(19) United States
(12) Patent Application Publication
(10) Pub. No.: US 2025/0118489 A1
(43) Pub. Date: Apr. 10, 2025

(54) WOUND CORE PRODUCING APPARATUS AND WOUND CORE PRODUCING METHOD

(71) Applicant: NIPPON STEEL CORPORATION, Tokyo (JP)

(72) Inventors: Takahito MIZUMURA, Tokyo (JP); Hisashi MOGI, Tokyo (JP)

(73) Assignee: NIPPON STEEL CORPORATION, Tokyo (JP)

(21) Appl. No.: 18/834,554

(22) PCT Filed: Feb. 2, 2023
(86) PCT No.: PCT/JP2023/003466

§ 371 Date: Jul. 30, 2024

(30) Foreign Application Priority Data
Feb. 4, 2022 (JP) 2022-016395

(51) Int. Cl. H01F 41/02; H01F 27/245

(52) U.S. Cl. CPC H01F 41/0233; H01F 27/245; H01F 41/0213

(57) ABSTRACT

This wound core producing apparatus (40) is a wound core producing apparatus (40), the wound core being formed by bending and laminating a steel sheet (21), the wound core producing apparatus (40) including a bending device (20) that bends the steel sheet (21), and a feed roll (60) that feeds the steel sheet (21) to the bending device (20), in which a diameter of the feed roll (60) is 5 mm to 500 mm, a pressure applied to the steel sheet (21) by the feed roll (60) is 0.4 MPa to 2.4 MPa, and a Shore hardness of an outer circumferential surface of the feed roll (60) measured at 45° C. is A38 or more and A90 or less.

### TECHNICAL FIELD OF THE INVENTION

The present invention relates to a wound core producing apparatus and a wound core producing method.

The present application claims priority based on Japanese Patent Application No. 2022-016395 filed in Japan on Feb. 4, 2022, the contents of which are incorporated herein by reference.

### RELATED ART

A wound core is widely used as a magnetic core for a transformer, a reactor, a noise filter, or the like. Conventionally, reduction of iron loss occurring in a core has been one of important problems from the viewpoint of high efficiency and the like, and reduction of iron loss has been studied from various viewpoints.

For example, Patent Document 1 discloses the following wound core producing method. In this producing method, a coated grain-oriented electrical steel sheet having a coating containing phosphorus on a surface is bent into a bent body, and a plurality of bent bodies are laminated in a sheet thickness direction to produce a wound core. When bending the coated grain-oriented electrical steel sheet, the bending is performed in a state in which a portion to be a bent region of the bent body is set to 150° C. or higher and 500° C. or lower. The plurality of obtained bent bodies are laminated in the sheet thickness direction. According to such a method, the number of deformation twins in the bent region of the bent body is suppressed, and a wound core in which iron loss is suppressed is obtained.

For example, in the method of Patent Document 2, the following wound core producing method is disclosed. In this producing method, a coated grain-oriented electrical steel sheet is prepared, and the coated grain-oriented electrical steel sheet is formed into the bent body. In the bending, the coated grain-oriented electrical steel sheet is bent under the condition that a portion to be the bent region of the bent body is heated to 45° C. or higher and 500° C. or lower and an absolute value of a local temperature gradient at an arbitrary position in a longitudinal direction of the coated grain-oriented electrical steel sheet is less than 400° C./mm in a flat region in the strain influence region to form the bent body. The plurality of bent bodies are laminated in a sheet thickness direction. According to such a method, the number of deformation twins in the bent region is suppressed, and a wound core in which iron loss is suppressed is obtained.

### CITATION LIST

### Patent Document

### [Patent Document 1]

PCT International Publication No. WO 2018/131613

### [Patent Document 2]

PCT International Publication No. WO 2020/218607

### SUMMARY OF INVENTION

### Problems to be Solved by the Invention

However, in the wound core producing apparatuses disclosed in Patent Documents 1 and 2, although about 1 to 2 wound cores can be produced, there is a possibility that a wound core in which iron loss is suppressed cannot be continuously produced.

The present invention has been made in view of the above problem and provides a wound core producing apparatus and a wound core producing method capable of stably producing a wound core in which iron loss is suppressed.

### Means for Solving the Problem

In order to solve the above problem, the present invention proposes the means described below.
<1> A wound core producing apparatus according to Aspect 1 of the present invention is a wound core producing apparatus, the wound core being formed by bending and laminating a steel sheet, the wound core producing apparatus including:
a bending device that bends the steel sheet; and
a feed roll that feeds the steel sheet to the bending device,
in which
a diameter of the feed roll is 5 mm to 500 mm,
a pressure applied to the steel sheet by the feed roll is 0.4 MPa to 2.4 MPa, and
a Shore hardness of an outer circumferential surface of the feed roll measured at 45° C. is A38 or more and A90 or less.
<2> According to Aspect 2 of the present invention, in the wound core producing apparatus according to Aspect 1, a material of the outer circumferential surface of the feed roll may be rubber.
<3> According to Aspect 3 of the present invention, in the wound core producing apparatus according to Aspect 2, the rubber of the feed roll may be one or more selected from the group consisting of diene-based rubber, olefin-based rubber; silicone rubber, and fluororubber.
<4> In a wound core producing method according to Aspect 4 of the present invention, a wound core is produced using the producing apparatus according to any one of Aspects 1 to 3.

### Effects of the Invention

According to the above aspects of the present invention, it is possible to provide a wound core producing apparatus and a wound core producing method capable of stably producing a wound core in which iron loss is suppressed.

### BRIEF DESCRIPTION OF THE DRAWINGS

FIG. 1 is a perspective view illustrating a wound core according to a first aspect.

FIG. 2 is a side view of the wound core in FIG. 1.

FIG. 3 is a side view illustrating a wound core according to a second aspect.

FIG. 4 is a side view illustrating a wound core according to a third aspect.

FIG. 5 is an enlarged side view of the vicinity of a corner portion of the wound core in FIG. 1.

FIG. 6 is an enlarged side view of an example of a bent region.

FIG. 7 is a side view of a bent body of the wound core in FIG. 1.

FIG. 8 is an explanatory view illustrating a first example of a wound core producing apparatus used in a wound core producing method.

FIG. 9 is a schematic view illustrating dimensions of a wound core produced at the time of characteristic evaluation.

### EMBODIMENTS OF THE INVENTION

### (Wound Core)

First, a wound core produced by a wound core producing apparatus according to an embodiment of the present invention will be described in detail. However, the present invention is not limited only to the configuration disclosed in the present embodiment, and various modifications can be made without departing from the gist of the present invention. Note that a numerical range described below includes the lower limit and the upper limit. A numerical value indicated as “more than” or “less than” is not included in the numerical range. In addition, unless otherwise specified, the unit “%” regarding the chemical composition means “mass %”.

Terms such as “parallel”, “perpendicular”, “identical”, and “at right angle”, values of length and angle, and the like, which specify shapes, geometric conditions, and degrees thereof, used in the present specification are not to be bound by a strict meaning but are to be interpreted including a range in which similar functions can be expected. In the present disclosure, substantially 90° allows an error of +3°, and means a range of 87° to 93°.

A wound core according to the present disclosure is a wound core formed by laminating, in a sheet thickness direction, a plurality of bent bodies formed from a coated grain-oriented electrical steel sheet, in which a coating is formed on at least one surface of the grain-oriented electrical steel sheet, such that the coating is on an outer side, in which the bent body has a bent region obtained by bending the coated grain-oriented electrical steel sheet, and a flat region adjacent to the bent region.

### “Coated Grain-Oriented Electrical Steel Sheet”

The coated grain-oriented electrical steel sheet in the present disclosure includes at least a grain-oriented electrical steel sheet (sometimes referred to as a “base steel sheet” in the present disclosure) and a coating formed on at least one surface of the base steel sheet. The coated grain-oriented electrical steel sheet has at least a primary coating as the coating and may further have another layer as necessary. Examples of the other layer include a secondary coating provided on the primary coating.

Hereinafter, the configuration of the coated grain-oriented electrical steel sheet will be described.

### <Grain-Oriented Electrical Steel Sheet>

In the coated grain-oriented electrical steel sheet constituting the wound core 10 according to the present disclosure, the base steel sheet is a steel sheet in which the orientation of grains is highly accumulated in a {110}<001> orientation. The base steel sheet has excellent magnetic properties in a rolling direction.

The base steel sheet used for the wound core according to the present disclosure is not particularly limited. As the base steel sheet, a known grain-oriented electrical steel sheet can be appropriately selected and used. Hereinafter, an example of a preferable base steel sheet will be described, but the base steel sheet is not limited to the following example.

The chemical composition of the base steel sheet is not particularly limited, but for example, it is preferable that the base steel sheet contains, in mass %, Si: 0.8% to 7%, C: more than 0% and 0.085% or less, acid-soluble Al: 0% to 0.065%, N: 0% to 0.012%, Mn: 0% to 1%, Cr: 0% to 0.3%, Cu: 0% to 0.4%, P: 0% to 0.5%, Sn: 0% to 0.3%, Sb: 0% to 0.3%, Ni: 0% to 1%, S: 0% to 0.015%, and Se: 0% to 0.015%, and the remainder is Fe and impurity elements.

The above chemical composition of the base steel sheet is a preferred chemical component for controlling the crystal orientation to a Goss texture accumulated in the {110}<001> orientation.

Among the elements in the base steel sheet, Si and C are basic elements (essential elements) except Fe, and acid-soluble Al, N, Mn, Cr, Cu, P, Sn, Sb, Ni, S, and Se are selected elements (optional elements). Since these selected elements may be contained depending on the object, it is not necessary to limit the lower limit, and these selected elements may not be substantially contained. In addition, even if these selected elements are contained as impurity elements, the effects of the present disclosure are not impaired. The base steel sheet contains Fe and impurity elements as the remainder of the basic elements and the selected elements.

However, when the Si content of the base steel sheet is 2.0% or more in mass %, classical eddy-current loss of the product is suppressed, which is preferable. The Si content of the base steel sheet is more preferably 3.0% or more. In addition, when the Si content of the base steel sheet is 5.0% or less in mass %, fracture of the steel sheet is less likely to occur in a hot rolling step and cold rolling, which is preferable. The Si content of the base steel sheet is more preferably 4.5% or less.

The “impurity element” means an element unintentionally mixed from ore as a raw material, scrap, a producing environment, or the like when the base steel sheet is industrially produced.

In addition, the grain-oriented electrical steel sheet generally undergoes purification annealing during secondary recrystallization. In the purification annealing, an inhibitor-forming element is discharged to the outside of the system. Particularly, for N and S, the concentration remarkably decreases to 50 ppm or less. Under normal purification annealing conditions, the concentration reaches 9 ppm or less, further 6 ppm or less, and a degree that cannot be detected by general analysis (1 ppm or less) if purification annealing is sufficiently performed.

The chemical component of the base steel sheet may be measured by a general analysis method of steel. For example, the chemical component of the base steel sheet may be measured by inductively coupled plasma-atomic emission spectrometry (ICP-AES). Specifically, for example, the chemical component can be specified by acquiring a test piece of 35 mm square from a center position in a width direction of the base steel sheet after removal of a coating and performing measurement under a condition based on a calibration curve created in advance using ICPS-8100 produced by Shimadzu Corporation or the like (measurement apparatus). C and S may be measured by a combustion-infrared absorption method, and N may be measured by an inert gas fusion-thermal conductivity method.

The chemical component of the base steel sheet is a component obtained by analyzing a component of a steel sheet obtained by removing a glass coating, a coating containing phosphorus, and the like described later from a grain-oriented electrical steel sheet by a method described later as the base steel sheet.

### <Primary Coating>

The primary coating is a coating directly formed on a surface of a grain-oriented electrical steel sheet as a base steel sheet without any other layer or film, and examples thereof include a glass coating. Examples of the glass coating include a coating having one or more oxides selected from forsterite (Mg₂SiO₄), spinel (MgAl₂O₄), and cordierite (Mg₂Al₄Si₅O₁₆).

The method for forming the glass coating is not particularly limited and can be appropriately selected from known methods. For example, a specific example of a method for producing the base steel sheet includes a method in which an annealing separator containing one or more selected from magnesia (MgO) and alumina (Al₂O₃) is applied to a cold-rolled steel sheet, and then finish annealing is performed. The annealing separator also has an effect of suppressing sticking of steel sheets during finish annealing. For example, when finish annealing is performed by applying the annealing separator containing magnesia, silica contained in the base steel sheet reacts with the annealing separator to form a glass coating containing forsterite (Mg₂SiO₄) on a base steel sheet surface.

For example, a coating containing phosphorus described later may be formed as a primary coating without forming a glass film on a surface of a grain-oriented electrical steel sheet.

The thickness of the primary coating is not particularly limited, but is preferably, for example, 0.5 μm or more and 3 μm or less from the viewpoint of forming the primary coating on the entire surface of a base steel sheet and suppressing peeling.

### <Other Coatings>

The coated grain-oriented electrical steel sheet may include a coating other than the primary coating. For example, it is preferable that the coated grain-oriented electrical steel sheet have a coating containing phosphorus as a secondary coating on the primary coating mainly for imparting insulation properties. The coating containing phosphorus is a coating formed on the outermost surface of the grain-oriented electrical steel sheet, and when the grain-oriented electrical steel sheet has a glass coating or an oxide coating as a primary coating, the coating containing phosphorus is formed on the primary coating. By forming a coating containing phosphorus on the glass coating formed as a primary coating film on the surface of the base steel sheet, high adhesion can be secured.

The coating containing phosphorus can be appropriately selected from conventionally known coatings. The coating containing phosphorus is preferably a phosphate-based coating, and particularly preferably a coating containing one or more of aluminum phosphate and magnesium phosphate as main components, and further containing one or more of chromium and silicon oxide as accessory components. According to the phosphate-based coating, insulation properties of the steel sheet are secured, and tension is imparted to the steel sheet to be excellent in reduction of iron loss.

The thickness of the coating containing phosphorus is not particularly limited but is preferably 0.5 μm or more and 3 μm or less from the viewpoint of securing insulation properties.

### <Sheet Thickness>

The sheet thickness of the coated grain-oriented electrical steel sheet is not particularly limited, and may be appropriately selected according to the application and the like, but is usually in the range of 0.10 mm to 0.50 mm, preferably 0.13 mm to 0.35 mm, and more preferably in the range of 0.15 mm to 0.30 mm.

### (Configuration of Wound Core)

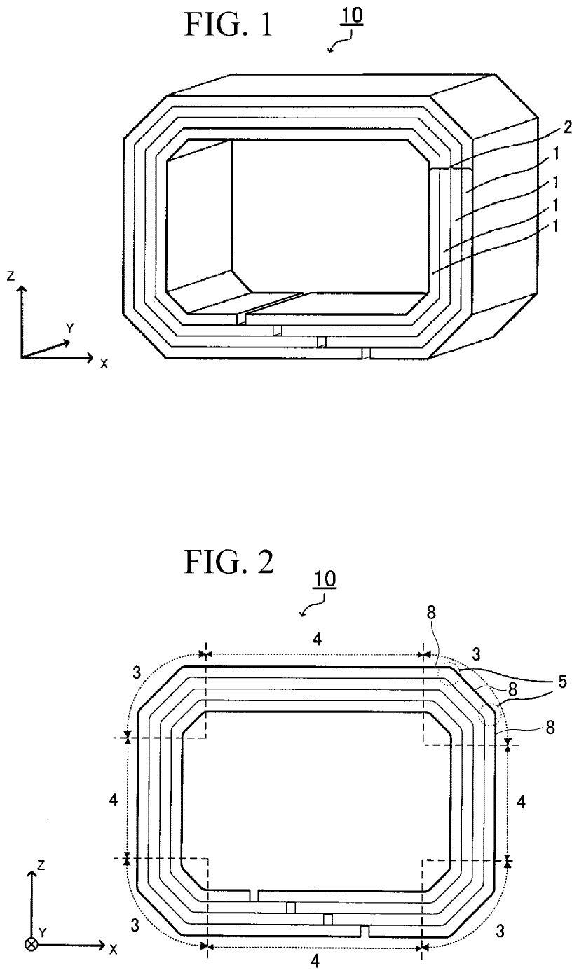

An example of a configuration of a wound core according to the present disclosure will be described with reference to a wound core 10 in FIGS. 1 and 2 as an example. FIG. 1 is a perspective view of a wound core 10, and FIG. 2 is a side view of the wound core 10 in FIG. 1.

In the present disclosure, viewing from the side means viewing in a width direction (Y-axis direction in FIG. 1) of a coated grain-oriented electrical steel sheet in a long shape constituting a wound core. The side view is a view illustrating a shape visually recognized by viewing from the side (a view in the Y-axis direction in FIG. 1). The sheet thickness direction is a sheet thickness direction of a coated grain-oriented electrical steel sheet, and means a direction perpendicular to a circumferential surface of a wound core in a state of being formed into a rectangular wound core. Here, the direction perpendicular to a circumferential surface means a direction perpendicular to the circumferential surface when the circumferential surface is viewed from the side. When the circumferential surface forms a curve in viewing the circumferential surface from the side, the direction perpendicular to the circumferential surface (sheet thickness direction) means a direction perpendicular to a tangent of the curve formed by the circumferential surface.

The wound core 10 is configured by laminating a plurality of bent bodies 1 in a sheet thickness direction thereof. That is, as illustrated in FIGS. 1 and 2, the wound core 10 has a substantially rectangular laminated structure including a plurality of bent bodies 1. The wound core 10 may be used as it is as a wound core. If necessary, the wound core 10 may be fixed using a fastening tool such as a known binding band. The bent body 1 is formed from a coated grain-oriented electrical steel sheet, in which a coating is formed on at least one surface of the grain-oriented electrical steel sheet as a base steel sheet.

As illustrated in FIGS. 1 and 2, each of the bent bodies 1 is formed in a rectangular shape by alternately continuing four flat portions 4 and four corner portions 3 along a circumferential direction. An angle formed by two flat portions 4 adjacent to each corner portion 3 is substantially 90°. Here, the circumferential direction means a direction around an axis of the wound core 10.

As illustrated in FIG. 2, in the wound core 10, each of the corner portions 3 of the bent body 1 has two bent regions 5. The bent region 5 is a region having a curved bent shape in viewing the bent body 1 from the side, and a more specific definition thereof will be described later. As will also be described later, in the two bent regions 5, bent angles in total are substantially 90° in viewing the bent body 1 from the side.

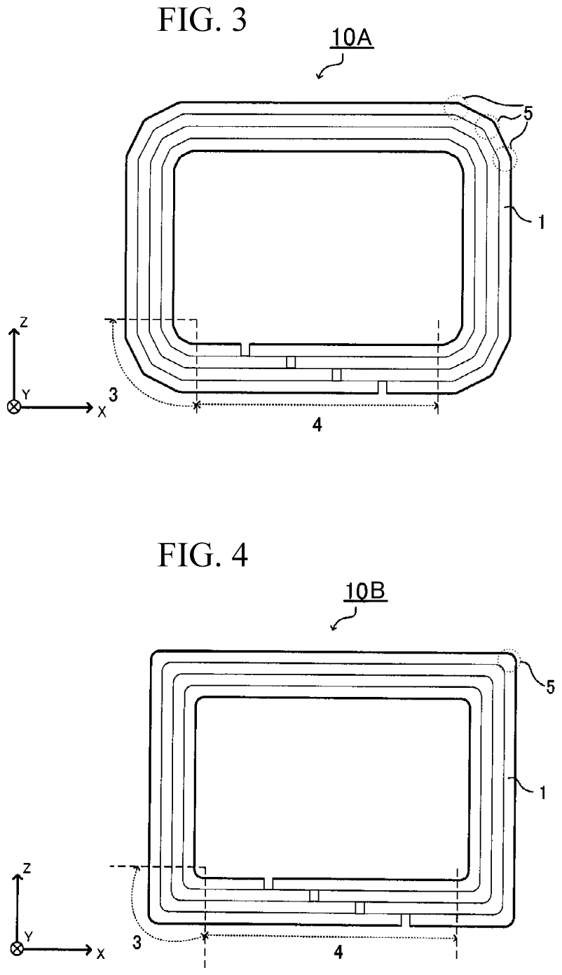

Each of the corner portions 3 of the bent body 1 may have three bent regions 5 in one corner portion 3 as in a wound core 10A according to a second aspect of the present disclosure illustrated in FIG. 3. Further, as in a wound core 10B according to a third aspect illustrated in FIG. 4, one corner portion 3 may have one bent region 5. That is, each of the corner portions 3 of the bent body 1 may have one or more bent regions 5 so that the steel sheet is bent by substantially 90°.

As illustrated in FIG. 2, the bent body 1 has a flat region 8 adjacent to a bent region 5. As the flat region 8 adjacent to a bent region 5, there are two flat regions 8 shown in (1) and (2) below.
(1) A flat region 8 positioned between a bent region 5 and a bent region 5 (between two bent regions 5 adjacent in the circumferential direction) in one corner portion 3 and adjacent to each bent region 5.
(2) A flat region 8 adjacent to each bent region 5 as a flat portion 4.

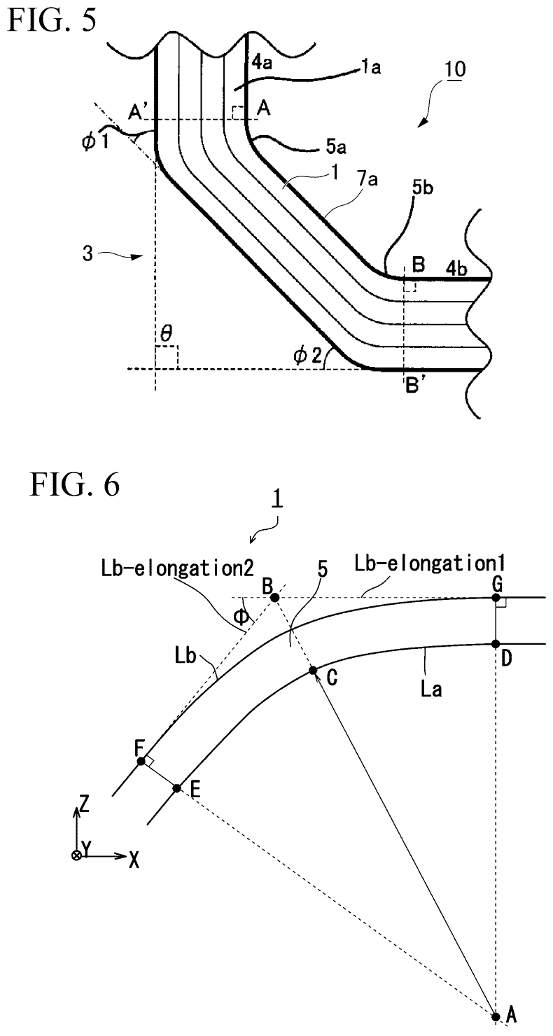

FIG. 5 is an enlarged side view of the vicinity of a corner portion 3 in the wound core 10 in FIG. 1.

As illustrated in FIG. 5, when one corner portion 3 has two bent regions 5a and 5b, a bent region 5a (curved portion) is continuous from a flat portion 4a (straight portion) which is a flat region of the bent body 1, and further, a flat region 7a (straight portion), a bent region 5b (curved portion), and a flat portion 4b (straight portion) which is a flat region are continuous therebeyond.

In the wound core 10, a region from a line segment A-A′ to a line segment B-B′ in FIG. 5 is the corner portion 3. A point A is an end point on a flat portion 4a side in the bent region 5a of the bent body 1a disposed on the innermost side of the wound core 10. A point A′ is an intersection point of a straight line passing through the point A and perpendicular (sheet thickness direction) to a sheet surface of the bent body 1a and the outermost surface of the wound core 10 (an outer circumferential surface of the bent body 1 disposed on the outermost side of the wound core 10). Similarly, a point B is an end point on a flat portion 4b side in the bent region 5b of the bent body 1a disposed on the innermost side of the wound core 10. A point B′ is an intersection point of a straight line passing through the point B and perpendicular (sheet thickness direction) to a sheet surface of the bent body 1a and the outermost surface of the wound core 10. In FIG. 5, an angle formed by two flat portions 4a and 4b adjacent to each other with the corner portion 3 interposed therebetween (angle formed by intersection of extension lines of the flat portions 4a and 4b) is θ, and in the example in FIG. 5, the θ is substantially 90° The bent angles of the bent regions Sa and 5b will be described later, but in FIG. 5, the bent angles in total φ1+φ2 of the bent regions 5a and Sb are substantially 90°.

The bent region 5 will be described in more detail with reference to FIG. 6. FIG. 6 is an enlarged side view of an example of the bent region 5 of the bent body 1. The bent angle φ of the bent region 5 means an angular difference generated between a flat region on a rear side in a bending direction and a flat region on a front side in the bending direction in the bent region 5 of the bent body 1. Specifically, the bent angle φ of the bent region 5 is represented as an angle φ of a complementary angle of an angle formed by two imaginary lines Lb-elongation 1 and Lb-elongation 2 obtained by extending straight portions continuous to both sides (points F and G) of a curved portion included in a line Lb representing an outer surface of the bent body 1 in the bent region 5.

The bent angle of each bent region 5 is substantially 90° or less, and the bent angles in total of all the bent regions 5 in one corner portion 3 are substantially 90°.

In viewing the bent body 1 from the side, when points D and E on a line La representing an inner surface of the bent body 1 and the points F and G on the line Lb representing the outer surface of the bent body 1 are defined as follows, the bent region 5 indicates a region surrounded by (1A) a line delimited by the point D and the point E on the line La representing the inner surface of the bent body 1, (2A) a line delimited by the point F and the point G on the line Lb representing the outer surface of the bent body 1, (3A) a straight line connecting the point D and the point G, and (4A) a straight line connecting the point E and the point F.

Here, the point D, the point E, the point F, and the point G are defined as follows.

In viewing from the side, a point at which a straight line AB connecting a center point A of a radius of curvature in a curved portion included in the line La representing the inner surface of the bent body 1 and an intersection point B of the two imaginary lines Lb-elongation 1 and Lb-elongation 2 obtained by extending straight portions adjacent to both sides of the curved portion included in the line Lb representing the outer surface of the bent body 1 intersects the line La representing the inner surface of the bent body 1 is defined as an origin C,
a point separated from the origin C by a distance m represented by the following formula (1) in one direction along the line La representing the inner surface of the bent body 1 is defined as the point D,
a point separated from the origin C by the distance m in another direction along the line La representing the inner surface of the bent body is defined as the point E,
an intersection point between a straight portion facing the point D among the straight portions included in the line Lb representing the outer surface of the bent body and an imaginary line drawn perpendicularly to the straight portion facing the point D and passing through the point D is defined as the point G, and
an intersection point between a straight portion facing the point E among the straight portions included in the line Lb representing the outer surface of the bent body and an imaginary line drawn perpendicularly to the straight portion facing the point E and passing through the point E is defined as the point F. The intersection point A is an intersection point obtained by extending a line segment EF and a line segment DG inward on the opposite side of the point B.

m=r×(π×φ/180) (1)

In formula (1), m represents a distance from the origin C, and r represents a distance (radius of curvature) from the center point A to the origin C. The radius of curvature r of the bent body 1 disposed on an inner surface side of the wound core 10 is preferably, for example, 1 mm or more and 5 mm or less.

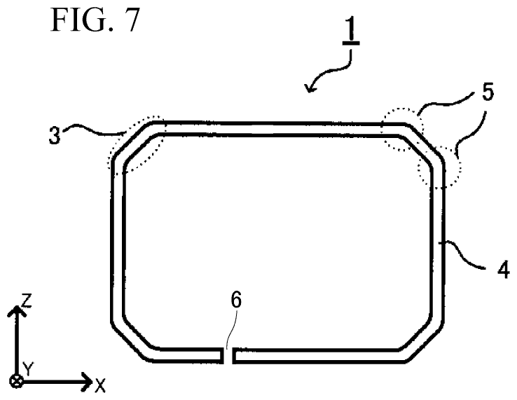

FIG. 7 is a side view of the bent body 1 of the wound core 10 in FIG. 1. As illustrated in FIG. 7, the bent body 1 is obtained by bending a coated grain-oriented electrical steel sheet and includes four corner portions 3 and four flat portions 4, so that one coated grain-oriented electrical steel sheet forms a substantially rectangular ring in viewing from the side. More specifically, the bent body 1 has a structure in which one flat portion 4 is provided with a gap 6 in which both end surfaces in a longitudinal direction of the coated grain-oriented electrical steel sheet face each other, and the other three flat portions 4 do not include the gap 6.

However, the wound core 10 may have a laminated structure having a substantially rectangular shape as a whole in viewing from the side. The wound core 10 may have a configuration in which two flat portions 4 include the gap 6 and the other two flat portions 4 do not include the gap 6. In this case, a bent body is formed of two coated grain-oriented electrical steel sheets.

It is desirable to prevent generation of a gap between two adjacent layers in a sheet thickness direction at the time of producing the wound core. Therefore, in the two adjacent bent bodies, the length of the steel sheet and the position of the bent region are adjusted such that an outer circumferential length of a flat portion 4 of a bent body disposed inside is equal to an inner circumferential length of a flat portion 4 of a bent body disposed outside.

### (Wound Core Producing Apparatus)

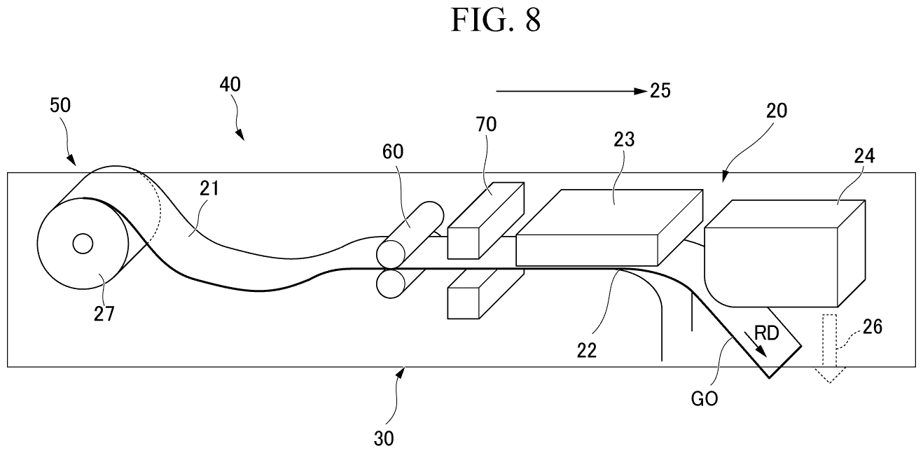

Next, a wound core producing apparatus according to the present disclosure will be described. As illustrated in FIG. 8, the wound core producing apparatus 40 is a producing apparatus 40 for a wound core 10 formed by bending and laminating a steel sheet (coated grain-oriented electrical steel sheet) 21, and includes a bending device 20 that bends the coated grain-oriented electrical steel sheet 21, and a feed roll 60 that feeds the coated grain-oriented electrical steel sheet 21 to the bending device 20. The wound core producing apparatus 40 of the present disclosure may include a decoiler 50, a cutting device 70, a heating device 30, and a laminating device (not illustrated) that laminates bent bodies 1 to produce a wound core 10.

### “Decoiler”

The decoiler 50 unwinds the coated grain-oriented electrical steel sheet 21 from a coil 27 of the coated grain-oriented electrical steel sheet 21. The coated grain-oriented electrical steel sheet 21 unwound from the decoiler 50 is conveyed toward the feed roll 60.

### “Heating Device”

The heating device 30 heats the feed roll 60, the cutting device 70, the bending device 20, and the grain-oriented electrical steel sheet 21. The heating device is not particularly limited as long as it can heat the feed roll 60, the cutting device 70, the bending device 20, and the coated grain-oriented electrical steel sheet 21. Examples of the heating device 30 include an infrared furnace.

The heating temperature is not limited as long as the temperature range of the portion to be the bent region 5 (bent region forming portion) of the bent body 1 can be set to 70° C. or higher and 300° C. or lower. The heating temperature (achieving temperature) of the bent region can be controlled by, for example, an output (furnace temperature, current value, etc.) of the heating device 30. It is a matter of course that these conditions vary depending on the steel sheet to be used, the heating device 30, and the like, and it is not intended to uniformly indicate and define quantitative conditions. Therefore, in the present disclosure, a heating state is defined by a temperature distribution obtained by temperature measurement described later. However, it is easy for a person skilled in the art who performs heat treatment of a steel sheet as a normal operation to reproduce a desired temperature state in a practical range according to the steel sheet to be used and the heating device 30 based on measurement data of steel sheet temperature as described later, and such control does not hinder implementation of the wound core and the producing method thereof of the present disclosure.

When the temperature of the portion to be the bent region 5 of the bent body 1 is lower than 70° C., it is impossible to suppress iron loss due to generation of deformation twins in the bent region 5. Therefore, the temperature of the portion to be the bent region 5 of the bent body 1 is 70° C. or higher. The temperature is preferably 100° C. or higher, and more preferably 150° C. or higher. In addition, when the temperature of the portion to be the bent region 5 of the bent body 1 exceeds 300° C., the magnetic domain control effect may be lost. Therefore, the upper limit of the temperature of the bent region forming portion is preferably controlled to 300° C. or lower. By heating the feed roll 60, the cutting device 70, the bending device 20, and the coated grain-oriented electrical steel sheet 21, the heating device 30 can stably heat the portion to be the bent region 5 (bent region forming portion) of the bent body 1 in a temperature range of 70° C. or higher and 300° C. or lower. As a result, iron loss of the wound core 10 can be suppressed.

“Temperature measurement of bent region forming portion” Here, the temperature of the bent region forming portion of the coated grain-oriented electrical steel sheet 21 in bending defined by the present disclosure is measured as follows.

As the temperature, for example, the temperature of the die 22 of the bending device 20 is measured by a thermocouple, Specifically, at a position of 20 mm in a direction opposite to the conveyance direction 25 of the coated grain-oriented electrical steel sheet 21 from an R-end of the die 22, thermocouples are installed at three locations that equally divide the entire width of the die 22 in a width direction of the die 22, and measurement is continuously performed by the thermocouples. Since the temperature of the die 22 and the temperature of the coated grain-oriented electrical steel sheet 21 are substantially equal, the temperature of the die 22 is regarded as the temperature of the bent region forming portion. The R-end refers to a boundary portion between a curved surface and a flat surface of the die 22. The average value of the obtained measured values is defined as the temperature of the bent region forming portion. The width direction of the die 22 is a direction corresponding to the width direction of the coated grain-oriented electrical steel sheet 21.

### “Feed Roll”

The feed roll 60 conveys the coated grain-oriented electrical steel sheet 21 to the bending device 20. The feed roll 60 adjusts a conveyance direction 25 of the coated grain-oriented electrical steel sheet 21 immediately before being supplied into the bending device 20. The feed roll 60 adjusts the conveyance direction 25 of the coated grain-oriented electrical steel sheet 21 in a horizontal direction, and then supplies the coated grain-oriented electrical steel sheet 21 to the bending device 20.

The Shore hardness of an outer circumferential surface of the feed roll 60 measured at 45° C. is A38 or more and A90 or less. The outer circumferential surface is a surface in contact with the coated grain-oriented electrical steel sheet 21. When the Shore hardness of the outer circumferential surface of the feed roll 60 measured at 45° C. is A38 or more and A90 or less, the wound core can be stably produced even when the temperature of the feed roll 60 becomes 80° C. or higher. More preferably, the Shore hardness of the outer circumferential surface of the feed roll 60 at 150° C. is A50 or more and A90 or less. Still more preferably, the Shore hardness of the outer circumferential surface of the feed roll 60 at 270° C. is A50 or more and A90 or less.

The hardness (Shore hardness) of the outer circumferential surface of the feed roll 60 used for the outer circumferential surface of the feed roll 60 can be measured in accordance with JIS K6253-3:2012. The relative humidity at the time of measurement is, for example, 45% to 53%. For measurement of the Shore hardness, a type A durometer is used. The measurement is performed 3 seconds after pressurization.

The material of the outer circumferential surface of the feed roll 60 is not particularly limited as long as the Shore hardness of the outer circumferential surface of the feed roll 60 measured at 45° C. is A38 or more and A90 or less. Examples of the material of the outer circumferential surface of the feed roll 60 include rubber, polystyrene, polyvinyl chloride, and phenolic resin. The material of the outer circumferential surface of the feed roll 60 is preferably rubber.

The rubber used for the outer circumferential surface of the feed roll 60 is, for example, one or more selected from the group consisting of diene-based rubber, olefin-based rubber, silicone rubber, and fluororubber.

Examples of the diene-based rubber include styrene-butadiene rubber. Examples of the olefin-based rubber include ethylene propylene rubber and ethylene propylene diene rubber. Examples of the silicone rubber include dimethyl silicone rubber and methyl vinyl silicone rubber. Examples of the fluororubber include vinylidene fluoride-based rubber and tetrafluoroethylene-propylene-based fluororubber. Examples of the vinylidene fluoride-based rubber include propylene hexafluoride-vinylidene fluoride copolymers. The above rubbers may be used alone, or two or more kinds thereof may be mixed.

The static friction coefficient of the outer circumferential surface of the feed roll 60 is preferably 0.07 to 0.92.

The diameter of the feed roll 60 is 5 mm to 500 mm. When the diameter of the feed roll is set to 5 mm to 500 mm, it is possible to stably produce a wound core in which iron loss is suppressed even when the temperature of the feed roll 60 becomes 80° C. or higher.

The pressure applied to the coated grain-oriented electrical steel sheet 21 by the feed roll 60 is 0.4 MPa to 2.4 MPa. When the pressure is set to 0.4 MPa to 2.4 MPa, it is possible to stably produce a wound core in which iron loss is suppressed even when the temperature of the feed roll 60 becomes 80° C. or higher.

The surface temperature of the feed roll 60 is preferably 80° C. or higher. The surface temperature of the feed roll is more preferably 90° C. or higher. The upper limit of the surface temperature of the feed roll 60 is not particularly limited, but is 300° C. or lower. More preferably, the surface temperature of the feed roll 60 is 260° C. or lower. The surface temperature of the feed roll 60 can be measured using, for example, an infrared radiation thermometer.

The conveyance speed of the coated grain-oriented electrical steel sheet 21 is preferably 5 m/min to 200 m/min. When the conveyance speed satisfies the above range, it is possible to more stably produce a wound core in which iron loss is suppressed.

The cutting device 70 is installed between the feed roll 60 and the bending device 20. The coated grain-oriented electrical steel sheet 21 is cut by the cutting device 70, and then bent. The cutting method is not particularly limited. The cutting method is, for example, shearing.

### “Bending Device”

The bending device 20 bends the coated grain-oriented electrical steel sheet 21 conveyed from the feed roll 60. A bent body 1 has a bent region obtained by bending and a flat region adjacent to the bent region. In the bent body 1, a flat portion and a corner portion are alternately continuous. In each corner portion, an angle formed by two adjacent flat portions is substantially 90°.

The bending device 20 includes, for example, a die 22 and a punch 24 for press working. The bending device further includes a guide 23 for fixing the coated grain-oriented electrical steel sheet 21 and a cover (not illustrated). The cover covers the die 22, the punch 24, and the guide 23. After the bending device 20 bends the coated grain-oriented electrical steel sheet 21, the coated grain-oriented electrical steel sheet 21 may be cut by the cutting device 70. After the cutting device 70 cuts the coated grain-oriented electrical steel sheet 21, the bending device 20 may perform bending.

The coated grain-oriented electrical steel sheet 21 is conveyed in the conveyance direction 25 and fixed at a position set in advance. Next, the punch 24 pressurizes up to a predetermined position in a pressurization direction 26 with a predetermined force set in advance, so that the bent body 1 having a bent region of a desired bent angle φ is obtained.

### “Laminating Device”

A plurality of bent bodies 1 are laminated in a sheet thickness direction such that the coating of each bent body 1 is on an outer side. The bent bodies 1 are laminated by aligning corner portions 3 and being overlapped in a sheet thickness direction to form a laminated body 2 having a substantially rectangular shape in viewing from the side. As a result, it is possible to obtain the wound core having low iron loss according to the present disclosure. The obtained wound core may be further fixed using a known binding band or fastening tool as necessary.

As described above, since in the wound core producing apparatus 40 according to the present disclosure, the material of the outer circumferential surface of the feed roll 60 is rubber, the Shore hardness of the rubber measured at 45° C. is A38 or more and A90 or less, the diameter of the feed roll 60 is 5 mm to 500 mm, and the pressure applied to the steel sheet by the feed roll 60 is 0.4 MPa to 2.4 MPa, it is possible to stably produce a wound core in which iron loss is suppressed even when the temperature of the feed roll becomes 80° C. or higher.

The present disclosure is not limited to the above embodiments. The above embodiments are examples, and anything having substantially the identical configuration as the technical idea described in the claims of the present disclosure and exhibiting the same operation and effects is included in the technical scope of the present disclosure. The wound core producing method according to the present disclosure produces a wound core using the above wound core producing apparatus.

### EXAMPLES

Hereinafter, examples (experimental examples) will be described, but the wound core producing apparatus according to the present disclosure is not limited to the following examples. The wound core producing apparatus according to the present disclosure can adopt various conditions as long as the object of the present disclosure is achieved without departing from the gist of the present disclosure, The conditions in the following examples are condition examples adopted to confirm the operability and effects.

### [Produce of Wound Core]

A glass coating (thickness: 1.0 μm) containing forsterite (Mg₂SiO₄) as a primary coating and a secondary coating (thickness: 2.0 μm) containing aluminum phosphate were formed in this order on a base steel sheet (sheet thickness: 0.23 mm) having the above-described chemical composition to produce a coated grain-oriented electrical steel sheet.

The feed roll, the cutting device, and the bending device were heated so that the temperature of bent region forming portions of these coated grain-oriented electrical steel sheets was room temperature (23° C.) or a temperature range of 50° C. to 300° C. as shown in Tables 3 to 11, and bending was performed at a bent angle φ of 45° under the conditions shown in Tables 3 to 11 to obtain a bent body having a bent region. The temperature of the bent region forming portions was measured by the above-described method. The temperature of the roll was measured at a position within 20 mm from the roll surface using infrared thermography.

The pressing pressure of the roll is a pressure applied to the coated grain-oriented electrical steel sheet by the feed roll.

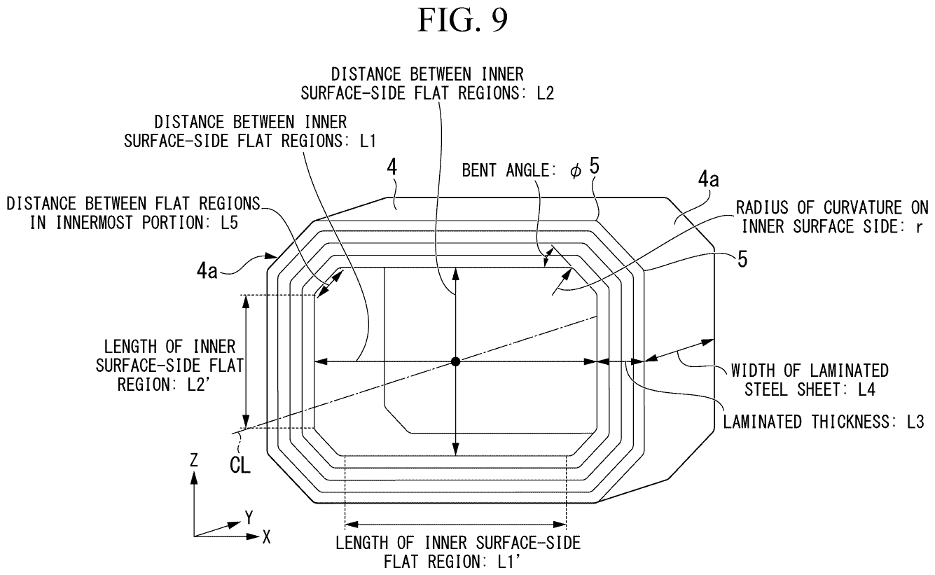

Subsequently, the bent body was laminated in a sheet thickness direction to obtain a wound core having dimensions shown in FIG. 9. L1 is a distance (distance between inner surface-side flat regions) parallel to an X-axis direction and between grain-oriented electrical steel sheets 21 parallel to each other on the innermost circumference of the wound core in a plane cross section including a center CL. L2 is a distance (distance between inner surface-side flat regions) parallel to a Z-axis direction and between grain-oriented electrical steel sheets 1 parallel to each other on the innermost circumference of the wound core in a longitudinal cross section including the center CL. L3 is a laminated thickness (thickness in the stacking direction) of the wound core in the plane cross section including the center CL and parallel to the X-axis direction. LA is a width of the laminated steel sheet of the wound core in the plane cross section parallel to the X-axis direction and including the center CL. L5 is a distance between flat regions (distance between bent regions) disposed adjacent to each other in the innermost portion of the wound core and so as to form a right angle. In other words, L5 is a length in a longitudinal direction of a flat region having the shortest length among the flat regions of the grain-oriented electrical steel sheet on the innermost circumference. r is a radius of curvature of a bent region on an inner surface side of the wound core, and φ is a bent angle of a bent region of the wound core. The wound core according to the present example has a structure in which a flat region whose inner surface-side flat region distance is L1 is divided at substantially a center of the distance L1, and two cores having a “substantially U-shaped” shape are coupled. In each example, L1: 197 mm, L2: 66 mm, L3: 47 mm, L4: 152.4 mm, L5: 4 mm, and radius of curvature r: 1 mm were set.

### [Shore Hardness of Rubber]

The Shore hardness of the rubber used for the material of the outermost circumference of the feed roll was measured. As the sample, the rubbers in Table 1 were used. The Shore hardness of the rubber was measured in accordance with JIS K6253-3:2012. The Shore hardness is obtained by adding A in front of the number in the column of Shore hardness In Table 1. For example, if the number in the column of Shore hardness in Table 1 is 40, the Shore hardness is A40. The measurement temperature was 23° C. to 270° C. For measurement, a type A durometer was used. The obtained results are shown in Table 2. The relative humidity at the time of measurement was set to 45 to 53%. The measurement was performed 3 seconds after pressurization.

### [Evaluation of Iron Loss]

Iron loss was evaluated in building factor. In measurement of the building factor, for each wound core produced under the conditions of Tables 3 to 11, measurement using the excitation current method described in JIS C 2550-1 was performed under the conditions of a frequency of 50 Hz and a magnetic flux density of 1.7 T, and an iron loss value (core iron loss) WA of the wound core was measured. In addition, a sample having a width of 100 mm×a length of 500 mm was collected from a hoop (sheet width of 152.4 mm) of the grain-oriented electrical steel sheet used for the core, and this sample was subjected to measurement by an electrical steel sheet single sheet magnetic properties test using the H-coil method described in JIS C 2556 under the conditions of a frequency of 50 Hz and a magnetic flux density of 1.7 T to measure an iron loss value (iron loss of steel sheet) W_{B} of the material steel sheet single sheet. Then, the building factor (BF) was obtained by dividing the iron loss value WA by the iron loss value W_{B}. The case where BF was 1.19 or less was regarded as acceptable. The results are shown in Tables 3 to 11. “−” in Tables 3 to 11 means that the feed roll was damaged and the wound core could not be produced.

TABLE 1A

| Roll material No. | A | B | C | D | |
|---|---|---|---|---|---|
| Rubber type | Urethane rubber | Styrene-butadiene | Ethylene propylene | Silicone rubber | |
| | | rubber | rubber | | |
| Chemical structure | Polyurethane | Butadiene-Styrene | Ethylene propylene | Polysiloxane | |
| | | copolymer | copolymer | | |
| | | | (temary copolymer) | | |
| Static friction | 0.47 | 0.07 | 0.72 | 0.92 | |
| coefficient with | | | | | |
| coated grain- | | | | | |
| oriented electrical | | | | | |
| steel sheet | | | | | |
| Roll material No. | E | F | G | H | I |
| Rubber type | Fluororubber | Styrene-butadiene | Styrol resin | Soft PVC | Bakelite |
| | | rubber | | | |
| Chemical | Propylene | Butadiene-styrene | Polystyrene | Polyvinyl | Phenolic resin |
| structure | hexafluoride- | copolymer | | chloride | |
| | vinylidene | | | | |
| | fluoride | | | | |
| | copolymer | | | | |
| Static friction | 0.64 | 0.07 | 0.72 | 0.34 | 0.12 |
| coefficient with | | | | | |
| coated grain- | | | | | |
| oriented electrical | | | | | |
| steel sheet | | | | | |

TABLE 2

| | Roll material No. | | | | | | | | |
|---|---|---|---|---|---|---|---|---|---|
| Temperature | A | B | C | D | E | F | G | H | I |
| (° C.) | Shore hardness | | | | | | | | |
| 28 | 40 | 80 | 76 | 90 | 70 | 32 | 67 | 58 | 90 |
| 45 | 37 | 75 | 75 | 90 | 70 | 28 | 62 | 56 | 90 |
| 80 | 21 | 60 | 70 | 81 | 70 | 20 | 57 | 49 | 86 |
| 110 | 15 | 55 | 62 | 76 | 70 | 16 | 52 | 44 | 80 |
| 150 | 12 | 47 | 50 | 72 | 70 | 12 | 48 | 41 | 62 |
| 270 | 10 | 40 | 38 | 66 | 65 | 10 | 39 | 38 | 43 |

TABLE 3

| | | | Temperature | | | Building factor | | | |
|---|---|---|---|---|---|---|---|---|---|
| | Roll | Surface | of bent | Diameter | Pressing | First | Second | Third | Fourth |
| Experiment | material | temperature of | region forming | of roll | pressure of | wound | wound | wound | wound |
| No. | No. | roll (° C.) | portion (° C.) | (mm) | roll (MPa) | core | core | core | core |
| 1 | A | 23 | 23 | 30 | 0.4 | 1.24 | 1.24 | 1.24 | 1.24 |
| 2 | A | 50 | 43 | 30 | 0.4 | 1.21 | 1.21 | 1.21 | 1.21 |
| 3 | A | 70 | 55 | 30 | 0.4 | 1.20 | 1.20 | 1.20 | 1.20 |
| 4 | A | 80 | 64 | 30 | 0.4 | 1.15 | 1.15 | 1.15 | — |
| 5 | A | 130 | 100 | 30 | 0.4 | 1.10 | 1.10 | — | — |
| 6 | A | 200 | 140 | 30 | 0.4 | 1.08 | — | — | — |
| 7 | A | 250 | 185 | 30 | 0.4 | 1.07 | — | — | — |
| 8 | A | 300 | 210 | 30 | 0.4 | 1.05 | — | — | — |

TABLE 4

| | | | Temperature | | | Building factor | | | |
|---|---|---|---|---|---|---|---|---|---|
| | Roll | Surface | of bent | | Pressing | First | Second | Third | Fourth |
| Experiment | material | temperature of | region forming | Diameter of | pressure of | wound | wound | wound | wound |
| No. | No. | roll (° C.) | portion (° C.) | roll (mm) | roll (MPa) | core | core | core | core |
| 9 | B | 23 | 23 | 4 | 1.2 | 1.25 | 1.25 | 1.25 | 1.25 |
| 10 | B | 23 | 23 | 5 | 0 | 1.24 | 1.24 | 1.24 | 1.24 |
| 11 | B | 23 | 23 | 5 | 0.4 | 1.24 | 1.24 | 1.24 | 1.24 |
| 12 | B | 23 | 23 | 5 | 0.7 | 1.24 | 1.24 | 1.24 | 1.24 |
| 13 | B | 23 | 23 | 5 | 1.2 | 1.25 | 1.25 | 1.25 | 1.25 |
| 14 | B | 23 | 23 | 5 | 2.4 | 1.23 | 1.23 | 1.23 | 1.23 |
| 15 | B | 23 | 23 | 5 | 3.6 | 1.24 | 1.24 | 1.24 | 1.24 |
| 16 | B | 70 | 55 | 5 | 1.2 | 1.20 | 1.20 | 1.20 | 1.20 |
| 17 | B | 80 | 70 | 5 | 1.2 | 1.15 | 1.15 | 1.15 | 1.15 |
| 18 | B | 130 | 95 | 5 | 1.2 | 1.10 | 1.10 | — | — |
| 19 | B | 200 | 140 | 5 | 1.2 | 1.08 | — | — | — |
| 20 | B | 250 | 180 | 5 | 1.2 | 1.07 | — | — | — |
| 21 | B | 300 | 210 | 5 | 1.2 | 1.05 | — | — | — |
| 22 | B | 80 | 70 | 50 | 0 | 1.24 | 1.24 | 1.24 | 1.24 |
| 23 | B | 80 | 70 | 50 | 0.4 | 1.15 | 1.15 | 1.15 | 1.15 |
| 24 | B | 80 | 70 | 50 | 0.7 | 1.15 | 1.15 | 1.15 | 1.15 |
| 25 | B | 80 | 70 | 50 | 1.2 | 1.15 | 1.15 | 1.15 | 1.15 |
| 26 | B | 80 | 70 | 50 | 2.4 | 1.15 | 1.15 | 1.15 | 1.15 |
| 27 | B | 80 | 70 | 50 | 3.6 | 1.24 | 1.24 | 1.24 | 1.24 |
| 28 | B | 130 | 95 | 50 | 0 | 1.24 | 1.24 | — | — |
| 29 | B | 130 | 95 | 50 | 0.4 | 1.11 | 1.11 | — | — |
| 30 | B | 130 | 95 | 50 | 0.7 | 1.11 | 1.11 | — | — |
| 31 | B | 130 | 95 | 50 | 1.2 | 1.10 | 1.10 | — | — |
| 32 | B | 130 | 95 | 50 | 2.4 | 1.11 | 1.11 | — | — |
| 33 | B | 130 | 95 | 50 | 3.6 | 1.23 | 1.24 | — | — |
| 34 | B | 200 | 140 | 50 | 0 | 1.24 | — | — | — |
| 35 | B | 200 | 140 | 50 | 0.4 | 1.08 | — | — | — |
| 36 | B | 200 | 140 | 50 | 0.7 | 1.08 | — | — | — |
| 37 | B | 200 | 140 | 50 | 1.2 | 1.08 | — | — | — |
| 38 | B | 200 | 140 | 50 | 2.4 | 1.08 | — | — | — |
| 39 | B | 200 | 140 | 50 | 3.6 | 1.24 | — | — | — |
| 40 | B | 23 | 23 | 500 | 0 | 1.24 | 1.24 | 1.24 | 1.24 |
| 41 | B | 23 | 23 | 500 | 0.4 | 1.24 | 1.24 | 1.24 | 1.24 |
| 42 | B | 23 | 23 | 500 | 0.7 | 1.24 | 1.24 | 1.24 | 1.24 |
| 43 | B | 23 | 23 | 500 | 1.2 | 1.25 | 1.25 | 1.25 | 1.25 |
| 44 | B | 23 | 23 | 500 | 2.4 | 1.23 | 1.23 | 1.23 | 1.23 |
| 45 | B | 23 | 23 | 500 | 3.6 | 1.24 | 1.24 | 1.24 | 1.24 |
| 46 | B | 80 | 70 | 500 | 0 | 1.24 | 1.24 | 1.24 | 1.24 |
| 47 | B | 80 | 70 | 500 | 0.4 | 1.15 | 1.15 | 1.15 | 1.15 |
| 48 | B | 80 | 70 | 500 | 0.7 | 1.15 | 1.15 | 1.15 | 1.15 |
| 49 | B | 80 | 70 | 500 | 1.2 | 1.15 | 1.15 | 1.15 | 1.15 |
| 50 | B | 80 | 70 | 500 | 2.4 | 1.15 | 1.15 | 1.15 | 1.15 |
| 51 | B | 80 | 70 | 500 | 3.6 | 1.24 | 1.24 | 1.24 | 1.24 |
| 52 | B | 130 | 95 | 500 | 0 | 1.24 | 1.24 | — | — |
| 53 | B | 130 | 95 | 500 | 0.4 | 1.11 | 1.11 | — | — |
| 54 | B | 130 | 95 | 500 | 0.7 | 1.11 | 1.11 | — | — |
| 55 | B | 130 | 95 | 500 | 1.2 | 1.10 | 1.10 | — | — |
| 56 | B | 130 | 95 | 500 | 2.4 | 1.11 | 1.11 | — | — |
| 57 | B | 130 | 95 | 500 | 3.6 | 1.24 | 1.24 | — | — |
| 58 | B | 200 | 140 | 500 | 0 | 1.24 | — | — | — |
| 59 | B | 200 | 140 | 500 | 0.4 | 1.08 | — | — | — |
| 60 | B | 200 | 140 | 500 | 0.7 | 1.08 | — | — | — |
| 61 | B | 200 | 140 | 500 | 1.2 | 1.08 | — | — | — |
| 62 | B | 200 | 140 | 500 | 2.4 | 1.08 | — | — | — |
| 63 | B | 200 | 140 | 500 | 3.6 | 1.24 | — | — | — |
| 64 | B | 80 | 70 | 600 | 0 | 1.23 | 1.23 | 1.23 | 1.23 |
| 65 | B | 80 | 70 | 600 | 0.4 | 1.23 | 1.23 | 1.23 | 1.23 |
| 66 | B | 80 | 70 | 600 | 0.7 | 1.23 | 1.23 | 1.23 | 1.23 |
| 67 | B | 80 | 70 | 600 | 1.2 | 1.23 | 1.23 | 1.23 | 1.23 |
| 68 | B | 80 | 70 | 600 | 2.4 | 1.23 | 1.23 | 1.23 | 1.23 |
| 69 | B | 80 | 70 | 600 | 3.6 | 1.23 | 1.23 | 1.23 | 1.23 |

TABLE 5

| | | | Temperature | | | Building factor | | | |
|---|---|---|---|---|---|---|---|---|---|
| | Roll | Surface | of bent | | Pressing | First | Second | Third | Fourth |
| Experiment | material | temperature of | region forming | Diameter of | pressure | wound | wound | wound | wound |
| No. | No. | roll (° C.) | portion (° C.) | roll (mm) | of roll (MPa) | core | core | core | core |
| 70 | C | 23 | 23 | 4 | 1.2 | 1.25 | 1.25 | 1.25 | 1.25 |
| 71 | C | 23 | 23 | 5 | 0 | 1.24 | 1.24 | 1.24 | 1.24 |
| 72 | C | 23 | 23 | 5 | 0.4 | 1.24 | 1.24 | 1.24 | 1.24 |
| 73 | C | 23 | 23 | 5 | 0.7 | 1.24 | 1.24 | 1.24 | 1.24 |
| 74 | C | 23 | 23 | 5 | 1.2 | 1.25 | 1.25 | 1.25 | 1.25 |
| 75 | C | 23 | 23 | 5 | 2.4 | 1.23 | 1.23 | 1.23 | 1.23 |
| 76 | C | 23 | 23 | 5 | 3.6 | 1.24 | 1.24 | 1.24 | 1.24 |
| 77 | C | 50 | 43 | 5 | 1.2 | 1.20 | 1.20 | 1.20 | 1.20 |
| 78 | C | 80 | 70 | 5 | 1.2 | 1.17 | 1.17 | 1.17 | 1.17 |
| 79 | C | 90 | 76 | 5 | 1.2 | 1.13 | 1.13 | 1.13 | 1.13 |
| 80 | C | 130 | 100 | 5 | 1.2 | 1.10 | 1.10 | 1.10 | 1.10 |
| 81 | C | 200 | 140 | 5 | 1.2 | 1.08 | — | — | — |
| 82 | C | 250 | 185 | 5 | 1.2 | 1.07 | — | — | — |
| 83 | C | 300 | 210 | 5 | 1.2 | 1.05 | — | — | — |
| 84 | C | 130 | 100 | 50 | 0 | 1.24 | 1.24 | 1.24 | 1.24 |
| 85 | C | 130 | 100 | 50 | 0.4 | 1.11 | 1.11 | 1.11 | 1.11 |
| 86 | C | 130 | 100 | 50 | 0.7 | 1.11 | 1.11 | 1.11 | 1.11 |
| 87 | C | 130 | 100 | 50 | 1.2 | 1.10 | 1.10 | 1.10 | 1.10 |
| 88 | C | 130 | 100 | 50 | 2.4 | 1.11 | 1.11 | 1.11 | 1.11 |
| 89 | C | 130 | 100 | 50 | 3.6 | 1.24 | 1.24 | 1.24 | 1.24 |
| 90 | C | 200 | 140 | 50 | 0 | 1.24 | — | — | — |
| 91 | C | 200 | 140 | 50 | 0.4 | 1.08 | — | — | — |
| 92 | C | 200 | 140 | 50 | 0.7 | 1.08 | — | — | — |
| 93 | C | 200 | 140 | 50 | 1.2 | 1.08 | — | — | — |
| 94 | C | 200 | 140 | 50 | 2.4 | 1.08 | — | — | — |
| 95 | C | 200 | 140 | 50 | 3.6 | 1.24 | — | — | — |
| 96 | C | 130 | 100 | 500 | 0 | 1.24 | 1.24 | 1.24 | 1.24 |
| 97 | C | 130 | 100 | 500 | 0.4 | 1.11 | 1.11 | 1.11 | 1.11 |
| 98 | C | 130 | 100 | 500 | 0.7 | 1.11 | 1.11 | 1.11 | 1.11 |
| 99 | C | 130 | 100 | 500 | 1.2 | 1.10 | 1.10 | 1.10 | 1.10 |
| 100 | C | 130 | 100 | 500 | 2.4 | 1.11 | 1.11 | 1.11 | 1.11 |
| 101 | C | 130 | 100 | 500 | 3.6 | 1.24 | 1.24 | 1.24 | 1.24 |
| 102 | C | 130 | 100 | 500 | 6.2 | 1.24 | 1.24 | 1.24 | 1.24 |
| 103 | C | 130 | 100 | 500 | 11 | 1.24 | 1.24 | 1.24 | 1.24 |
| 104 | C | 200 | 140 | 500 | 0 | 1.24 | — | — | — |
| 105 | C | 200 | 140 | 500 | 0.4 | 1.08 | — | — | — |
| 106 | C | 200 | 140 | 500 | 0.7 | 1.08 | — | — | — |
| 107 | C | 200 | 140 | 500 | 1.2 | 1.08 | — | — | — |
| 108 | C | 200 | 140 | 500 | 2.4 | 1.08 | — | — | — |
| 109 | C | 200 | 140 | 500 | 3.6 | 1.24 | — | — | — |
| 110 | C | 130 | 100 | 600 | 0 | 1.24 | 1.24 | 1.24 | 1.24 |
| 111 | C | 130 | 100 | 600 | 0.4 | 1.24 | 1.24 | 1.24 | 1.24 |
| 112 | C | 130 | 100 | 600 | 0.7 | 1.24 | 1.24 | 1.24 | 1.24 |
| 113 | C | 130 | 100 | 600 | 1.2 | 1.24 | 1.24 | 1.24 | 1.24 |
| 114 | C | 130 | 100 | 600 | 2.4 | 1.24 | 1.24 | 1.24 | 1.24 |
| 115 | C | 130 | 100 | 600 | 3.6 | 1.24 | 1.24 | 1.24 | 1.24 |

TABLE 6

| | | | Temperature | | | Building factor | | | |
|---|---|---|---|---|---|---|---|---|---|
| | Roll | Surface | of bent | | Pressing | First | Second | Third | Fourth |
| Experiment | material | temperature of | region forming | Diameter of | pressure | wound | wound | wound | wound |
| No. | No. | roll (° C.) | portion (° C.) | roll (mm) | of roll (MPa) | core | core | core | core |
| 116 | D | 23 | 23 | 4 | 1.2 | 1.25 | 1.25 | 1.25 | 1.25 |
| 117 | D | 23 | 23 | 5 | 0 | 1.24 | 1.24 | 1.24 | 1.24 |
| 118 | D | 23 | 23 | 5 | 0.4 | 1.24 | 1.24 | 1.24 | 1.24 |
| 119 | D | 23 | 23 | 5 | 0.7 | 1.24 | 1.24 | 1.24 | 1.24 |
| 120 | D | 23 | 23 | 5 | 1.2 | 1.25 | 1.25 | 1.25 | 1.25 |
| 121 | D | 23 | 23 | 5 | 2.4 | 1.23 | 1.23 | 1.23 | 1.23 |
| 122 | D | 23 | 23 | 5 | 3.6 | 1.24 | 1.24 | 1.24 | 1.24 |
| 123 | D | 50 | 45 | 5 | 1.2 | 1.20 | 1.20 | 1.20 | 1.20 |
| 124 | D | 80 | 70 | 5 | 1.2 | 1.17 | 1.17 | 1.17 | 1.17 |
| 125 | D | 90 | 85 | 5 | 1.2 | 1.13 | 1.13 | 1.13 | 1.13 |
| 126 | D | 130 | 110 | 5 | 1.2 | 1.09 | 1.09 | 1.09 | 1.09 |
| 127 | D | 200 | 170 | 5 | 1.2 | 1.06 | 1.06 | 1.06 | 1.06 |
| 128 | D | 250 | 200 | 5 | 1.2 | 1.07 | 1.07 | 1.07 | 1.07 |
| 129 | D | 300 | 260 | 5 | 1.2 | 1.05 | — | — | — |
| 130 | D | 250 | 200 | 50 | 0 | 1.24 | 1.24 | 1.24 | 1.24 |
| 131 | D | 250 | 200 | 50 | 0.4 | 1.07 | 1.07 | 1.07 | 1.07 |
| 132 | D | 250 | 200 | 50 | 0.7 | 1.07 | 1.07 | 1.07 | 1.07 |
| 133 | D | 250 | 200 | 50 | 1.2 | 1.07 | 1.07 | 1.07 | 1.07 |
| 134 | D | 250 | 200 | 50 | 2.4 | 1.07 | 1.07 | 1.07 | 1.07 |
| 135 | D | 250 | 200 | 50 | 3.6 | 1.24 | 1.24 | 1.24 | 1.24 |
| 136 | D | 250 | 200 | 50 | 6.2 | 1.24 | 1.24 | 1.24 | 1.24 |
| 137 | D | 250 | 200 | 50 | 11 | 1.24 | 1.24 | 1.24 | 1.24 |
| 138 | D | 300 | 260 | 50 | 0 | 1.24 | — | — | — |
| 139 | D | 300 | 260 | 50 | 0.4 | 1.05 | — | — | — |
| 140 | D | 300 | 260 | 50 | 0.7 | 1.05 | — | — | — |
| 141 | D | 300 | 260 | 50 | 1.2 | 1.05 | — | — | — |
| 142 | D | 300 | 260 | 50 | 2.4 | 1.05 | — | — | — |
| 143 | D | 300 | 260 | 50 | 3.6 | 1.24 | — | — | — |
| 144 | D | 23 | 23 | 500 | 0 | 1.24 | 1.24 | 1.24 | 1.24 |
| 145 | D | 23 | 23 | 500 | 0.4 | 1.24 | 1.24 | 1.24 | 1.24 |
| 146 | D | 23 | 23 | 500 | 0.7 | 1.24 | 1.24 | 1.24 | 1.24 |
| 147 | D | 23 | 23 | 500 | 1.2 | 1.25 | 1.25 | 1.25 | 1.25 |
| 148 | D | 23 | 23 | 500 | 2.4 | 1.23 | 1.23 | 1.23 | 1.23 |
| 149 | D | 23 | 23 | 500 | 3.6 | 1.24 | 1.24 | 1.24 | 1.24 |
| 150 | D | 250 | 200 | 500 | 0 | 1.24 | 1.24 | 1.24 | 1.24 |
| 151 | D | 250 | 200 | 500 | 0.4 | 1.07 | 1.07 | 1.07 | 1.07 |
| 152 | D | 250 | 200 | 500 | 0.7 | 1.07 | 1.07 | 1.07 | 1.07 |
| 153 | D | 250 | 200 | 500 | 1.2 | 1.07 | 1.07 | 1.07 | 1.07 |
| 154 | D | 250 | 200 | 500 | 2.4 | 1.07 | 1.07 | 1.07 | 1.07 |
| 155 | D | 250 | 200 | 500 | 3.6 | 1.24 | 1.24 | 1.24 | 1.24 |
| 156 | D | 300 | 260 | 500 | 0 | 1.24 | — | — | — |
| 157 | D | 300 | 260 | 500 | 0.4 | 1.05 | — | — | — |
| 158 | D | 300 | 260 | 500 | 0.7 | 1.05 | — | — | — |
| 159 | D | 300 | 260 | 500 | 1.2 | 1.05 | — | — | — |
| 160 | D | 300 | 260 | 500 | 2.4 | 1.05 | — | — | — |
| 161 | D | 300 | 260 | 500 | 3.6 | 1.24 | — | — | — |
| 162 | D | 250 | 200 | 600 | 0 | 1.24 | 1.24 | 1.24 | 1.24 |
| 163 | D | 250 | 200 | 600 | 0.4 | 1.24 | 1.24 | 1.24 | 1.24 |
| 164 | D | 250 | 200 | 600 | 0.7 | 1.24 | 1.24 | 1.24 | 1.24 |
| 165 | D | 250 | 200 | 600 | 1.2 | 1.24 | 1.24 | 1.24 | 1.24 |
| 166 | D | 250 | 200 | 600 | 2.4 | 1.24 | 1.24 | 1.24 | 1.24 |
| 167 | D | 250 | 200 | 600 | 3.6 | 1.24 | 1.24 | 1.24 | 1.24 |
| 168 | D | 300 | 260 | 600 | 0 | 1.24 | — | — | — |
| 169 | D | 300 | 260 | 600 | 0.4 | 1.24 | — | — | — |
| 170 | D | 300 | 260 | 600 | 0.7 | 1.24 | — | — | — |
| 171 | D | 300 | 260 | 600 | 1.2 | 1.24 | — | — | — |
| 172 | D | 300 | 260 | 600 | 2.4 | 1.24 | — | — | — |
| 173 | D | 300 | 260 | 600 | 3.6 | 1.24 | — | — | — |

TABLE 7

| | | | Temperature | | | Building factor | | | |
|---|---|---|---|---|---|---|---|---|---|
| | Roll | Surface | of bent | | Pressing | First | Second | Third | Fourth |
| Experiment | material | temperature of | region forming | Diameter of | pressure | wound | wound | wound | wound |
| No. | No. | roll (° C.) | portion (° C.) | roll (mm) | of roll (MPa) | core | core | core | core |
| 174 | E | 23 | 23 | 4 | 1.2 | 1.25 | 1.25 | 1.25 | 1.25 |
| 175 | E | 23 | 23 | 5 | 0 | 1.24 | 1.24 | 1.24 | 1.24 |
| 176 | E | 23 | 23 | 5 | 0.4 | 1.24 | 1.24 | 1.24 | 1.24 |
| 177 | E | 23 | 23 | 5 | 0.7 | 1.24 | 1.24 | 1.24 | 1.24 |
| 178 | E | 23 | 23 | 5 | 1.2 | 1.25 | 1.25 | 1.25 | 1.25 |
| 179 | E | 23 | 23 | 5 | 2.4 | 1.23 | 1.23 | 1.23 | 1.23 |
| 180 | E | 23 | 23 | 5 | 3.6 | 1.24 | 1.24 | 1.24 | 1.24 |
| 181 | E | 50 | 45 | 5 | 1.2 | 1.20 | 1.20 | 1.20 | 1.20 |
| 182 | E | 80 | 70 | 5 | 1.2 | 1.17 | 1.17 | 1.17 | 1.17 |
| 183 | E | 90 | 85 | 5 | 1.2 | 1.13 | 1.13 | 1.13 | 1.13 |
| 184 | E | 130 | 110 | 5 | 1.2 | 1.09 | 1.09 | 1.09 | 1.09 |
| 185 | E | 200 | 170 | 5 | 1.2 | 1.06 | 1.06 | 1.06 | 1.06 |
| 186 | E | 250 | 200 | 5 | 1.2 | 1.05 | 1.07 | 1.07 | 1.07 |
| 187 | E | 300 | 260 | 5 | 1.2 | 1.03 | 1.03 | 1.03 | 1.03 |
| 188 | E | 300 | 260 | 50 | 0 | 1.24 | 1.24 | 1.24 | 1.24 |
| 189 | E | 300 | 260 | 50 | 0.4 | 1.02 | 1.02 | 1.02 | 1.02 |
| 190 | E | 300 | 260 | 50 | 0.7 | 1.03 | 1.03 | 1.03 | 1.03 |
| 191 | E | 300 | 260 | 50 | 1.2 | 1.03 | 1.03 | 1.03 | 1.03 |
| 192 | E | 300 | 260 | 50 | 2.4 | 1.02 | 1.02 | 1.02 | 1.02 |
| 193 | E | 300 | 260 | 50 | 3.6 | 1.24 | 1.24 | 1.24 | 1.24 |
| 194 | E | 300 | 260 | 500 | 0 | 1.24 | 1.24 | 1.24 | 1.24 |
| 195 | E | 300 | 260 | 500 | 0.4 | 1.02 | 1.02 | 1.02 | 1.02 |
| 196 | E | 300 | 260 | 500 | 0.7 | 1.03 | 1.03 | 1.03 | 1.03 |
| 197 | E | 300 | 260 | 500 | 1.2 | 1.03 | 1.03 | 1.03 | 1.03 |
| 198 | E | 300 | 260 | 500 | 2.4 | 1.02 | 1.02 | 1.02 | 1.02 |
| 199 | E | 300 | 260 | 500 | 3.6 | 1.24 | 1.24 | 1.24 | 1.24 |
| 200 | E | 300 | 260 | 600 | 0 | 1.24 | 1.24 | 1.24 | 1.24 |
| 201 | E | 300 | 260 | 600 | 0.4 | 1.24 | 1.24 | 1.24 | 1.24 |
| 202 | E | 300 | 260 | 600 | 0.7 | 1.24 | 1.24 | 1.24 | 1.24 |
| 203 | E | 300 | 260 | 600 | 1.2 | 1.24 | 1.24 | 1.24 | 1.24 |
| 204 | E | 300 | 260 | 600 | 2.4 | 1.24 | 1.24 | 1.24 | 1.24 |
| 205 | E | 300 | 260 | 600 | 3.6 | 1.24 | 1.24 | 1.24 | 1.24 |

TABLE 8

| | | | Temperature | | | Building factor | | | |
|---|---|---|---|---|---|---|---|---|---|
| | Roll | Surface | of bent | | Pressing | First | Second | Third | Fourth |
| Experiment | material | temperature of | region forming | Diameter of | pressure | wound | wound | wound | wound |
| No. | No. | roll (° C.) | portion (° C.) | roll (mm) | of roll (MPa) | core | core | core | core |
| 206 | F | 23 | 23 | 4 | 1.2 | 1.25 | 1.25 | 1.25 | 1.25 |
| 207 | F | 23 | 23 | 5 | 0 | 1.24 | 1.24 | 1.24 | 1.24 |
| 208 | F | 23 | 23 | 5 | 0.4 | 1.24 | 1.24 | 1.24 | 1.24 |
| 209 | F | 23 | 23 | 5 | 0.7 | 1.25 | 1.25 | 1.25 | 1.25 |
| 210 | F | 23 | 23 | 5 | 1.2 | 1.25 | 1.25 | 1.25 | 1.25 |
| 211 | F | 23 | 23 | 5 | 2.4 | 1.25 | 1.25 | 1.25 | 1.25 |
| 212 | F | 23 | 23 | 5 | 3.6 | 1.25 | 1.25 | 1.25 | 1.25 |
| 213 | F | 50 | 45 | 5 | 1.2 | 1.25 | 1.25 | 1.25 | — |
| 214 | F | 80 | 70 | 5 | 1.2 | 1.25 | 1.25 | — | — |
| 215 | F | 90 | 85 | 5 | 1.2 | 1.25 | — | — | — |
| 216 | F | 130 | 110 | 5 | 1.2 | 1.25 | — | — | — |
| 217 | F | 200 | 170 | 5 | 1.2 | 1.25 | — | — | — |
| 218 | F | 250 | 200 | 5 | 1.2 | 1.25 | — | — | — |
| 219 | F | 300 | 260 | 5 | 1.2 | — | — | — | — |
| 220 | F | 300 | 260 | 50 | 0.1 | — | — | — | — |
| 221 | F | 300 | 260 | 50 | 0.4 | — | — | — | — |
| 222 | F | 300 | 260 | 50 | 0.7 | — | — | — | — |
| 223 | F | 300 | 260 | 50 | 1.2 | — | — | — | — |
| 224 | F | 300 | 260 | 50 | 2.4 | — | — | — | — |
| 225 | F | 300 | 260 | 50 | 3.6 | — | — | — | — |
| 226 | F | 300 | 45 | 500 | 0 | 1.25 | 1.25 | 1.25 | — |
| 227 | F | 300 | 45 | 500 | 0.4 | 1.25 | 1.25 | 1.25 | — |
| 228 | F | 300 | 45 | 500 | 0.7 | 1.25 | 1.25 | 1.25 | — |
| 229 | F | 300 | 45 | 500 | 1.2 | 1.25 | 1.25 | 1.25 | — |
| 230 | F | 300 | 45 | 500 | 2.4 | 1.25 | 1.25 | 1.25 | — |
| 231 | F | 300 | 45 | 500 | 3.6 | 1.25 | 1.25 | 1.25 | — |

TABLE 9

| | | | Temperature | | | Building factor | | | |
|---|---|---|---|---|---|---|---|---|---|
| | Roll | Surface | of bent | | Pressing | First | Second | Third | Fourth |
| Experiment | material | temperature of | region forming | Diameter of | pressure | wound | wound | wound | wound |
| No. | No. | roll (° C.) | portion (° C.) | roll (mm) | of roll (MPa) | core | core | core | core |
| 232 | G | 23 | 23 | 4 | 1.2 | 1.25 | 1.25 | 1.25 | 1.25 |
| 233 | G | 23 | 23 | 5 | 0 | 1.24 | 1.24 | 1.24 | 1.2 |
| 234 | G | 23 | 23 | 5 | 0.4 | 1.24 | 1.24 | 1.24 | 1.2 |
| 235 | G | 23 | 23 | 5 | 0.7 | 1.24 | 1.24 | 1.24 | 1.24 |
| 236 | G | 23 | 23 | 5 | 1.2 | 1.25 | 1.25 | 1.25 | 1.25 |
| 237 | G | 23 | 23 | 5 | 2.4 | 1.23 | 1.23 | 1.23 | 1.23 |
| 238 | G | 23 | 23 | 5 | 3.6 | 1.24 | 1.24 | 1.24 | 1.2 |
| 239 | G | 50 | 43 | 5 | 1.2 | 1.20 | 1.20 | 1.20 | 1.20 |
| 240 | G | 80 | 70 | 5 | 1.2 | 1.17 | 1.17 | 1.17 | 1.17 |
| 241 | G | 90 | 76 | 5 | 1.2 | 1.13 | 1.13 | 1.13 | 1.13 |
| 242 | G | 130 | 100 | 5 | 1.2 | 1.10 | 1.10 | 1.10 | 1.10 |
| 243 | G | 200 | 140 | 5 | 1.2 | 1.08 | — | — | — |
| 244 | G | 250 | 185 | 5 | 1.2 | 1.07 | — | — | — |
| 245 | G | 300 | 210 | 5 | 1.2 | 1.05 | — | — | — |
| 246 | G | 130 | 100 | 50 | 0 | 1.24 | 1.24 | 1.24 | 1.24 |
| 247 | G | 130 | 100 | 50 | 0.4 | 1.11 | 1.11 | 1.11 | 1.11 |
| 248 | G | 130 | 100 | 50 | 0.7 | 1.11 | 1.11 | 1.1 | 1.11 |
| 249 | G | 130 | 100 | 50 | 1.2 | 1.10 | 1.10 | 1.10 | 1.10 |
| 250 | G | 130 | 100 | 50 | 2.4 | 1.11 | 1.11 | 1.11 | 1.11 |
| 251 | G | 130 | 100 | 50 | 3.6 | 1.24 | 1.24 | 1.24 | 1.24 |
| 252 | G | 200 | 140 | 50 | 0 | 1.24 | — | — | — |
| 253 | G | 200 | 140 | 50 | 0.4 | 1.08 | — | — | — |
| 254 | G | 200 | 140 | 50 | 0.7 | 1.08 | — | — | — |
| 255 | G | 200 | 140 | 50 | 1.2 | 1.08 | — | — | — |
| 256 | G | 200 | 140 | 50 | 2.4 | 1.08 | — | — | — |
| 257 | G | 200 | 140 | 50 | 3.6 | 1.24 | — | — | — |
| 258 | G | 130 | 100 | 500 | 0 | 1.24 | 1.24 | 1.24 | 1.24 |
| 259 | G | 130 | 100 | 500 | 0.4 | 1.11 | 1.11 | 1.11 | 1.11 |
| 260 | G | 130 | 100 | 500 | 0.7 | 1.11 | 1.11 | 1.11 | 1.11 |
| 261 | G | 130 | 100 | 500 | 1.2 | 1.11 | 1.11 | 1.11 | 1.11 |
| 262 | G | 130 | 100 | 500 | 2.4 | 1.11 | 1.11 | 1.11 | 1.11 |
| 263 | G | 130 | 100 | 500 | 3.6 | 1.25 | 1.24 | 1.24 | 1.24 |
| 264 | G | 130 | 100 | 500 | 6.2 | 1.24 | 1.25 | 1.24 | 1.25 |
| 265 | G | 130 | 100 | 500 | 11 | 1.25 | 1.24 | 1.24 | 1.25 |
| 266 | G | 200 | 140 | 500 | 0 | 1.25 | — | — | — |
| 267 | G | 200 | 140 | 500 | 0.4 | 1.08 | — | — | — |
| 268 | G | 200 | 140 | 500 | 0.7 | 1.08 | — | — | — |
| 269 | G | 200 | 140 | 500 | 1.2 | 1.08 | — | — | — |
| 270 | G | 200 | 140 | 500 | 2.4 | 1.08 | — | — | — |
| 271 | G | 200 | 140 | 500 | 3.6 | 1.24 | — | — | — |
| 272 | G | 130 | 100 | 600 | 0 | 1.25 | 1.24 | 1.25 | 1.24 |
| 273 | G | 130 | 100 | 600 | 0.4 | 1.25 | 1.25 | 1.24 | 1.25 |
| 274 | G | 130 | 100 | 600 | 0.7 | 1.25 | 1.25 | 1.24 | 1.25 |
| 275 | G | 130 | 100 | 600 | 1.2 | 1.25 | 1.24 | 1.25 | 1.24 |
| 276 | G | 130 | 100 | 600 | 2.4 | 1.25 | 1.25 | 1.24 | 1.25 |
| 277 | G | 130 | 100 | 600 | 3.6 | 1.25 | 1.25 | 1.24 | 1.25 |

TABLE 10

| | | | Temperature | | | Building factor | | | |
|---|---|---|---|---|---|---|---|---|---|
| | Roll | Surface | of bent | | Pressing | First | Second | Third | Fourth |
| Experiment | material | temperature of | region forming | Diameter of | pressure | wound | wound | wound | wound |
| No. | No. | roll (° C.) | portion (° C.) | roll (mm) | of roll (MPa) | core | core | core | core |
| 278 | H | 23 | 23 | 4 | 1.2 | 1.25 | 1.25 | 1.25 | 1.25 |
| 279 | H | 23 | 23 | 5 | 0 | 1.24 | 1.24 | 1.24 | 1.24 |
| 280 | H | 23 | 23 | 5 | 0.4 | 1.24 | 1.24 | 1.24 | 1.24 |
| 281 | H | 23 | 23 | 5 | 0.7 | 1.24 | 1.24 | 1.24 | 1.24 |
| 282 | H | 23 | 23 | 5 | 1.2 | 1.25 | 1.25 | 1.25 | 1.25 |
| 283 | H | 23 | 23 | 5 | 2.4 | 1.23 | 1.23 | 1.23 | 1.23 |
| 284 | H | 23 | 23 | 5 | 3.6 | 1.24 | 1.24 | 1.24 | 1.24 |
| 285 | H | 50 | 43 | 5 | 1.2 | 1.20 | 1.20 | 1.20 | 1.20 |
| 286 | H | 80 | 70 | 5 | 1.2 | 1.17 | 1.17 | 1.17 | 1.17 |
| 287 | H | 90 | 76 | 5 | 1.2 | 1.13 | 1.13 | 1.13 | 1.13 |
| 288 | H | 130 | 100 | 5 | 1.2 | 1.10 | 1.10 | — | — |
| 289 | H | 200 | 140 | 5 | 1.2 | 1.08 | — | — | — |
| 290 | H | 250 | 185 | 5 | 1.2 | 1.07 | — | — | — |
| 291 | H | 300 | 210 | 5 | 1.2 | 1.05 | — | — | — |
| 292 | H | 130 | 100 | 50 | 0 | 1.24 | 1.24 | 1.24 | 1.24 |
| 293 | H | 130 | 100 | 50 | 0.4 | 1.11 | 1.11 | 1.11 | 1.11 |
| 294 | H | 130 | 100 | 50 | 0.7 | 1.11 | 1.11 | 1.11 | 1.11 |
| 295 | H | 130 | 100 | 50 | 1.2 | 1.10 | 1.10 | 1.10 | 1.10 |
| 296 | H | 130 | 100 | 50 | 2.4 | 1.11 | 1.11 | 1.11 | 1.11 |
| 297 | H | 130 | 100 | 50 | 3.6 | 1.24 | 1.24 | 1.24 | 1.24 |
| 298 | H | 200 | 140 | 50 | 0 | 1.24 | — | — | — |
| 299 | H | 200 | 140 | 50 | 0.4 | 1.08 | — | — | — |
| 300 | H | 200 | 140 | 50 | 0.7 | 1.08 | — | — | — |
| 301 | H | 200 | 140 | 50 | 1.2 | 1.08 | — | — | — |
| 302 | H | 200 | 140 | 50 | 2.4 | 1.08 | — | — | — |
| 303 | H | 200 | 140 | 50 | 3.6 | 1.24 | — | — | — |
| 304 | H | 130 | 100 | 500 | 0 | 1.24 | 1.24 | 1.24 | 1.24 |
| 305 | H | 130 | 100 | 500 | 0.4 | 1.11 | 1.11 | 1.11 | 1.11 |
| 306 | H | 130 | 100 | 500 | 0.7 | 1.11 | 1.11 | 1.11 | 1.11 |
| 307 | H | 130 | 100 | 500 | 1.2 | 1.11 | 1.11 | 1.11 | 1.11 |
| 308 | H | 130 | 100 | 500 | 2.4 | 1.11 | 1.11 | 1.11 | 1.11 |
| 309 | H | 130 | 100 | 500 | 3.6 | 1.25 | 1.24 | 1.24 | 1.24 |
| 310 | H | 130 | 100 | 500 | 6.2 | 1.24 | 1.25 | 1.24 | 1.25 |
| 311 | H | 130 | 100 | 500 | 11 | 1.25 | 1.24 | 1.24 | 1.25 |
| 312 | H | 200 | 140 | 500 | 0 | 1.25 | — | — | — |
| 313 | H | 200 | 140 | 500 | 0.4 | 1.08 | — | — | — |
| 314 | H | 200 | 140 | 500 | 0.7 | 1.08 | — | — | — |
| 315 | H | 200 | 140 | 500 | 1.2 | 1.08 | — | — | — |
| 316 | H | 200 | 140 | 500 | 2.4 | 1.08 | — | — | — |
| 317 | H | 200 | 140 | 500 | 3.6 | 1.24 | — | — | — |
| 318 | H | 90 | 78 | 600 | 0 | 1.25 | 1.24 | 1.25 | 1.24 |
| 319 | H | 90 | 78 | 600 | 0.4 | 1.25 | 1.25 | 1.24 | 1.25 |
| 320 | H | 90 | 78 | 600 | 0.7 | 1.25 | 1.25 | 1.24 | 1.25 |
| 321 | H | 90 | 78 | 600 | 1.2 | 1.25 | 1.24 | 1.25 | 1.24 |
| 322 | H | 90 | 78 | 600 | 2.4 | 1.25 | 1.25 | 1.24 | 1.25 |
| 323 | H | 90 | 78 | 600 | 3.6 | 1.25 | 1.25 | 1.24 | 1.25 |

TABLE 11

| | | | Temperature | | | Building factor | | | |
|---|---|---|---|---|---|---|---|---|---|
| | Roll | Surface | of bent | Diameter | Pressing | First | Second | Third | Fourth |
| Experiment | material | temperature of | region forming | of roll | pressure | wound | wound | wound | wound |
| No. | No. | roll (° C.) | portion (° C.) | (mm) | of roll (MPa) | core | core | core | core |
| 324 | I | 23 | 23 | 4 | 1.2 | 1.25 | 1.25 | 1.25 | 1.25 |
| 325 | I | 23 | 23 | 5 | 0 | 1.24 | 1.24 | 1.24 | 1.24 |
| 326 | I | 23 | 23 | 5 | 0.4 | 1.24 | 1.24 | 1.24 | 1.24 |
| 327 | I | 23 | 23 | 5 | 0.7 | 1.24 | 1.24 | 1.24 | 1.24 |
| 328 | I | 23 | 23 | 5 | 1.2 | 1.25 | 1.25 | 1.25 | 1.25 |
| 329 | I | 23 | 23 | 5 | 2.4 | 1.23 | 1.23 | 1.23 | 1.23 |
| 330 | I | 23 | 23 | 5 | 3.6 | 1.24 | 1.24 | 1.24 | 1.24 |
| 331 | I | 50 | 45 | 5 | 1.2 | 1.20 | 1.20 | 1.20 | 1.20 |
| 332 | I | 80 | 70 | 5 | 1.2 | 1.17 | 1.17 | 1.17 | 1.17 |
| 333 | I | 90 | 85 | 5 | 1.2 | 1.13 | 1.13 | 1.13 | 1.13 |
| 334 | I | 130 | 110 | 5 | 1.2 | 1.09 | 1.09 | 1.09 | 1.09 |
| 335 | I | 200 | 170 | 5 | 1.2 | 1.06 | 1.06 | 1.06 | 1.06 |
| 336 | I | 250 | 200 | 5 | 1.2 | 1.05 | 1.07 | 1.07 | 1.07 |
| 337 | I | 300 | 260 | 5 | 1.2 | 1.03 | 1.03 | — | — |
| 338 | I | 300 | 260 | 50 | 0 | 1.24 | 1.24 | — | — |
| 339 | I | 300 | 260 | 50 | 0.4 | 1.02 | 1.02 | — | — |
| 340 | I | 300 | 260 | 50 | 0.7 | 1.03 | 1.03 | — | — |
| 341 | I | 300 | 260 | 50 | 1.2 | 1.03 | 1.03 | — | — |
| 342 | I | 300 | 260 | 50 | 2.4 | 1.02 | 1.02 | — | — |
| 343 | I | 300 | 260 | 50 | 3.6 | 1.24 | 1.24 | — | — |
| 344 | I | 300 | 260 | 500 | 0 | 1.24 | 1.24 | — | — |
| 345 | I | 300 | 260 | 500 | 0.4 | 1.02 | 1.02 | — | — |
| 346 | I | 300 | 260 | 500 | 0.7 | 1.03 | 1.03 | — | — |
| 347 | I | 300 | 260 | 500 | 1.2 | 1.03 | 1.03 | — | — |
| 348 | I | 300 | 260 | 500 | 2.4 | 1.02 | 1.02 | — | — |
| 349 | I | 300 | 260 | 500 | 3.6 | 1.24 | 1.24 | — | — |
| 350 | I | 300 | 260 | 600 | 0 | 1.24 | 1.24 | — | — |
| 351 | I | 300 | 260 | 600 | 0.4 | 1.24 | 1.24 | — | — |
| 352 | I | 300 | 260 | 600 | 0.7 | 1.24 | 1.24 | — | — |
| 353 | I | 300 | 260 | 600 | 1.2 | 1.24 | 1.24 | — | — |
| 354 | I | 300 | 260 | 600 | 2.4 | 1.24 | 1.24 | — | — |
| 355 | I | 300 | 260 | 600 | 3.6 | 1.24 | 1.24 | — | — |

On the other hand, as shown in the results of Tables 4 to 11, when the wound core was produced under the conditions that the Shore hardness at 45° C. of the outer circumferential surface of the feed roll was A38 or more and A90 or less, the diameter of the feed roll was 5 mm to 500 mm, and the pressure applied to the steel sheet by the feed roll was 0.4 MPa to 2.4 MPa, it was possible to stably produce up to the fourth wound core while suppressing iron loss even when the temperature of the roll became 80° C. On the other hand, as shown in Tables 3 and 8, in the case of using urethane rubber and styrene-butadiene rubber having a Shore hardness at 45° C. of less than A38, when the roll temperature became 80° C., the fourth wound core could not be produced. As shown in Tables 4 to 7 and Tables 9 to 11, when the diameter of the feed roll and the pressure applied to the steel sheet by the feed roll were out of the range, the building factor was inferior. In addition, in the case of using the roll materials No. C, No. D, No. E, and No. I having a Shore hardness at 150° C. of A50 or more and 90 or less, it was possible to stably produce up to the fourth wound core even when the surface temperature of the feed roll was 130° C. Regarding the roll materials No. D and No. E, which are rubbers having a Shore hardness at 270° C. of A50 or more and 90 or less, it was possible to produce up to the fourth wound core even when the surface temperature of the feed roll was 250° C. In the case of using the roll material No. E, it was possible to produce up to the fourth wound core even when the surface temperature of the feed roll was 300° C.

### Field of Industrial Application

According to the present disclosure, it is possible to stably produce a wound core in which iron loss is suppressed. Therefore, industrial applicability is large.

### BRIEF DESCRIPTION OF THE REFERENCE SYMBOLS

1 Bent body
2 Laminated body
3 Corner portion
4, 4a, 4b Flat portion
5, 5a, 5b Bent region
6 Gap
8 Flat region
10 Wound core
20 Bending device
30 Heating device
40 Producing apparatus
21 Coated grain-oriented electrical steel sheet
22 Die
23 Guide
24 Punch
25 Conveyance direction
26 Pressurization direction

1. A wound core producing apparatus, the wound core being formed by bending and laminating a steel sheet, the wound core producing apparatus comprising:
a bending device that bends the steel sheet; and
a feed roll that feeds the steel sheet to the bending device,
wherein
a diameter of the feed roll is 5 mm to 500 mm,
a pressure applied to the steel sheet by the feed roll is 0.4 MPa to 2.4 MPa, and
a Shore hardness of an outer circumferential surface of the feed roll measured at 45° C. is A38 or more and A90 or less.

2. The wound core producing apparatus according to claim 1, wherein a material of the outer circumferential surface of the feed roll is rubber.

3. The wound core producing apparatus according to claim 2, wherein the rubber is one or more of diene-based rubber, olefin-based rubber, silicone rubber, and fluororubber.

4. A wound core producing method, comprising producing a wound core using the wound core producing apparatus according to claim 1.

5. A wound core producing method, comprising producing a wound core using the wound core producing apparatus according to claim 2.

6. A wound core producing method, comprising producing a wound core using the wound core producing apparatus according to claim 3.
